(19) United States
(12) Patent Application Publication
(10) Pub. No.: US 2007/0094436 A1
(43) Pub. Date: Apr. 26, 2007

(54) System and method for thermal management in PCI express system

(76) Inventors: William Fred Keown JR., Raleigh, NC (US); Albert Vincent Makley, Raleigh, NC (US); Cory Allen Chapman, Raleigh, NC (US); Kenneth Scott Seethaler, Raleigh, NC (US)

Correspondence Address: ROGITZ & ASSOCIATES, 750 B STREET, SUITE 3120, SAN DIEGO, CA, 92101, US

(21) Appl. No.: 11/254,477

(22) Filed: Oct. 20, 2005

(51) Int. Cl. G06F 13/40

(52) U.S. Cl. 710/307

(57) ABSTRACT

The number of lanes used to communicate with a plug-in graphics card over a PCI Express bus is dynamically established based on sensed temperature in the system, to maximize the number of lanes used while remaining below temperature limits.

### FIELD OF THE INVENTION

The present invention relates generally to managing temperature in computer systems that use buses such as PCI Express buses.

### BACKGROUND OF THE INVENTION

The processors of computers such as personal computers, laptop computers, and the like communicate with other system component over data buses. One type of bus is that known as a Peripheral Component Interconnect (PCI) Express bus that allows a processor to communicate with powerful plug-in graphics cards.

As recognized by the present invention, with decreasing computer size and hence decreased cooling capacity, powerful plug-in graphics cards have a tendency to cause the system to rise in temperature through excessive processor and system use. This can then cause damage to components within the computer system through exposure to excessive heat buildup, thereby affecting the thermal performance of that system. The current solution to regulate temperature within the computer is to regulate fan speed according to system temperature, i.e. the fan speed increases as the internal temperature rises, and vice versa, but this method can be insufficient to cool at higher plug-in card power consumptions. Further, the present invention recognizes that attempting to manage temperature by speeding up or slowing down the processor clock speed can result in penalizing the performance of the entire system when only a single component, such as a high power graphics card, might be the thermal culprit.

### SUMMARY OF THE INVENTION

A computer has a processor that executes logic to dynamically establish a number of lanes used to communicate with a plug-in graphics card over a PCI Express bus based on a parameter that is thermally related. The parameter may be temperature, in which case a temperature sensor sends a temperature signal to the processor.

As set forth further below, the logic maximizes the number of lanes used while remaining below a temperature setpoint. Specifically, the logic increases the number of lanes used if adequate thermal overhead exists between the setpoint and the temperature sensed by the sensor, and it decrease the number of lanes used if the temperature sensed by the sensor is determined to be too high. The logic can access a data structure containing characterizations of candidate components that might be plugged into the computer to communicate with the processor, as part of establishing the number of lanes.

In another aspect, a method for operating a computer includes dynamically establishing the number of lanes used to communicate with a plug-in graphics card over a PCI Express bus based on sensed temperature in the computer to maximize the number of lanes used while remaining below a temperature threshold.

In still another aspect, a computer system has a processor and a component supported by a housing, and bus means are between the processor and component. The bus means include plural communication lanes. Means are provided for sensing temperature in the system. The processor receives signals from the sensing means and in response establishes a number of operational lanes in the bus means.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting computer that can use the present invention;

FIG. 2 is a flow chart of a non-limiting implementation of preliminary plug-in card characterization logic; and

FIG. 3 is a flow chart of a non-limiting implementation of the thermal management logic.

### DETAILED DESCRIPTION OF THE PREFERRED EMBODIMENT

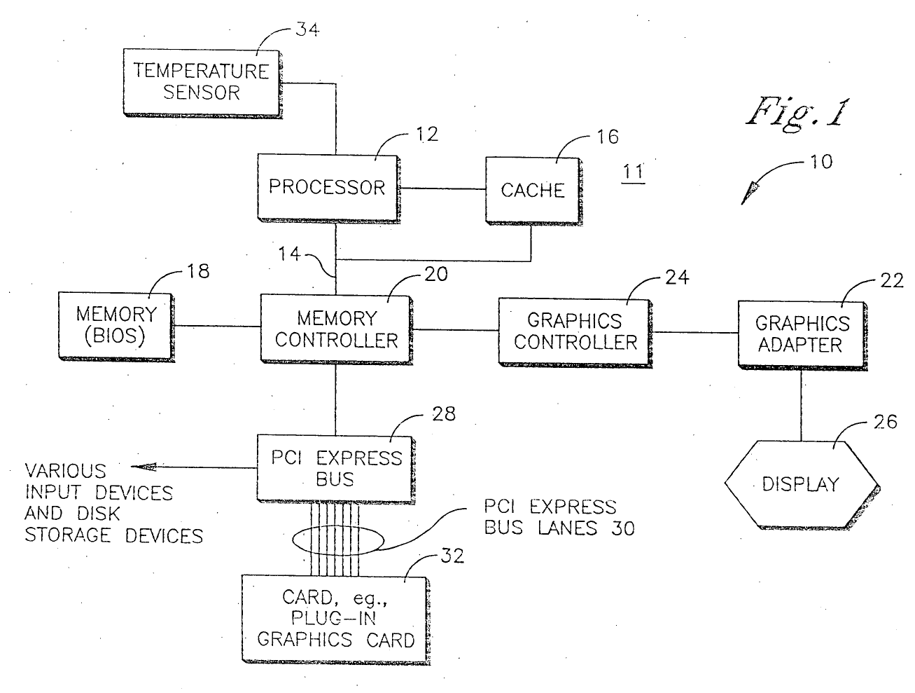

Referring initially to FIG. 1, a high-level block diagram of a data processing system, generally designated 10, is shown in which the present invention may be implemented. The system 10 in one non-limiting embodiment is a personal computer or laptop computer that can include a housing, schematically represented at 11, for holding the components below. The system 10 includes a processor 12, which may be, without limitation, a PowerPC processor available from International Business Machines Corporation of Armonk, N.Y. (or other processors common to the industry). The processor 12 is connected to a processor bus 14, and a cache 16, which is used to stage data to and from the processor 12 at reduced access latency, is also connected to the processor bus 14. In non-limiting embodiments the processor 12 can access data from the cache 16 or from a system solid state memory 18 by way of a memory controller function 20. The cache 16 may include volatile memory such as DRAM and the memory 18 may include non-volatile memory such as flash memory. Also, the memory controller 20 is connected to a memory-mapped graphics adapter 22 by way of a graphic bus controller 24, and the graphics adapter 22 provides a connection for a monitor 26 on which the user interface of software executed within data processing system 10 is displayed.

The non-limiting memory controller 20 may also be connected to a Peripheral Component Interconnect (PCI) Express bus 28 that allows data transfer at rates including 2.5 Gigabits/second using a layered structure. The PCI Express bus 28 includes plural links 30 of transmit and receive communication paths, with each link being referred to herein as a “lane”. Essentially, each lane 30 consists of two low-voltage, differentially driven pair of signals, i.e. a transmit pair and a receive pair. The PCI Express bus standard envisions multiple operational modes. For example, in one operational mode, only a single lane may be used, whereas in other operational modes, two four, eight, sixteen, or more lanes may be used.

PCI Express thus defines a standardized method of transferring symmetric data between the processor 12 and an add-in board or card or other device 32. In non-limiting implementations the device 32 may be a plug-in graphics card that is designed to operate in plural operating modes, i.e., to communicate with the processor 12 over the PCI Express bus 28 on, e.g., only a single lane 30 or using all sixteen lanes 30 or some other number of lanes therebetween. Other devices 32 may be used, e.g., video cards, other types of integrated circuits, etc.

FIG. 1 indicates that various input/output (I/O) devices may be included in the system 10, potentially connected to the PCI Express bus or other data bus of the system as appropriate. These devices may include, without limitation, disk storage devices and input devices such as keyboards and mice.

Concluding the description of FIG. 1, one or more temperature sensors 34 may be included in the system 10 and may input temperature signals to the processor 12. Without limitation, the sensor(s) 34 may be thermal diodes or other types of sensors such as thermocouples, RTDs, thermistors, etc. The sensor(s) 34 are mounted on, e.g., the system motherboard adjacent the processor 12, or adjacent the most temperature-sensitive component of the system 10, or on the plug-in card 32, or other suitable location.

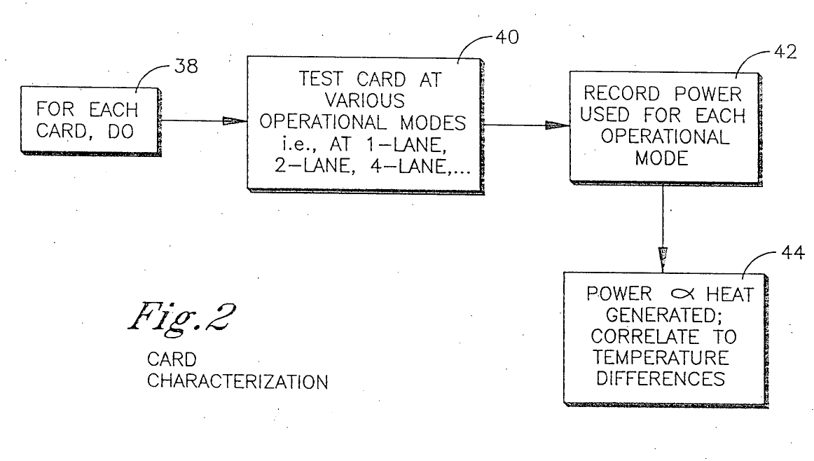

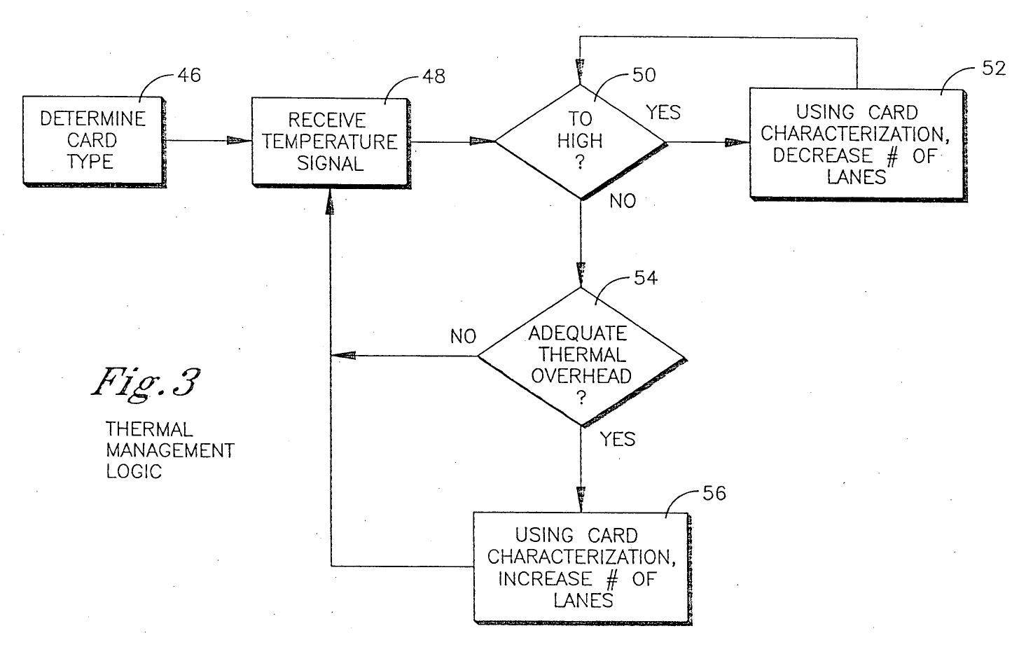

FIGS. 2 and 3 show logic in flow chart format for ease of exposition. The logic may be implemented by the processor 12 executing code in BIOS stored in the memory 18, although other controllers within the system 10 alternatively may execute the logic. While the logic is shown in flow chart form for convenience, it is to be understood that in implementation it may take other forms than literal flow chart form, e.g., state logic may be used.

Moving to FIG. 2, the flow chart of a non-limiting implementation of preliminary plug-in card characterization logic is shown. Commencing at block 36, the present logic as might be implemented in, e.g., system BIOS executes a DO loop for each candidate plug-in graphics card. When the processor has recognized the new plug-in graphics card, the logic moves to block 38, where the logic tests the plug-in graphics card at various operational modes. These different operational modes may include, but are not limited to, operating different numbers of lanes through the PCI Express bus. At block 40 the logic takes the results of these tests and records the power usage for each operational mode, and then at block 42, the power readings may be correlated to heat generated within the system, it being understood that the generated heat generally is directly proportional to the power consumed. The power measurements can be determined by means known in the art. At block 44 the logic can empirically correlate heat to temperature differences for the particular configuration of the system being used. The data collected through this process may be stored in, e.g., the memory 18 or other suitable location in, e.g., tabular form, for use in FIG. 3.

FIG. 3 outlines the process of dynamically establishing an adequate number of lanes to be used based on measured temperature from the sensor 34. Beginning at block 46, the logic determines the plug-in graphics card type. After the card type has been determined by the logic, the various operational modes the card might have and the associated heat and/or temperatures that have been correlated to the various modes in FIG. 2 are obtained by the processor from the data structure in which the characterization information was stored.

Then the logic moves to block 48 where the processor receives a signal with information regarding the parameter of temperature from, e.g., the sensor 34 shown in FIG. 1. In some implementations direct heat measurements may be used or calculated from the temperature signals. In any case, at decision diamond 50, the logic uses the actually sensed signal, e.g., a temperature signal, to determine if the temperature exceeds, e.g., a design specification threshold. If the temperature is determined to be too high, the logic then moves to block 52 where the logic uses the card characterization data from the logic set forth in FIG. 2 to decrease the number of operating lanes. At this point the logic loops back to decision diamond 50.

On the other hand, when it is determined at decision diamond 50 that the temperature parameter is acceptably low, the logic flows to decision diamond 54 to determine whether the processor has adequate thermal overhead to run efficiently without causing damage to any system hardware. If the logic concludes that there is not enough thermal overhead, the logic loops back to block 48. However, should there be adequate thermal overhead, at block 56 the logic once again uses the card characterization determined in FIG. 2 to increase the number of operational lanes. Accordingly, the skilled artisan will appreciate that when adequate thermal overhead exists to increase performance by increasing the number of lanes used, the logic does so at block 56. In other words, if the actual temperature is not only not too high, but is sufficiently low, lanes are added to the communication path, whereas lanes are removed from the communication path when temperature indicates that system thermal limits are in danger of violation. In this way, the number of lanes used is maximized, while remaining below the temperature setpoint.

While the particular SYSTEM AND METHOD FOR THERMAL MANAGEMENT IN PCI EXPRESS SYSTEM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A computer comprising:
a processor executing logic to dynamically establish a number of lanes used to communicate with a plug-in graphics card over a PCI Express bus based on at least one parameter that is thermally related.

2. The computer of claim 1, wherein the parameter is temperature.

3. The computer of claim 2, comprising a temperature sensor sending a signal to the processor, wherein the parameter is temperature sensed by the sensor.

4. The computer of claim 3, wherein the logic maximizes the number of lanes used while remaining below at least one temperature setpoint.

5. The computer of claim 1, wherein the logic is embodied by BIOS.

6. The computer of claim 4, wherein the logic increases the number of lanes used if adequate thermal overhead exists between the setpoint and the temperature sensed by the sensor.

7. The computer of claim 6, wherein the logic decreases the number of lanes used if the temperature sensed by the sensor is determined to be too high.

8. The computer of claim 1, wherein the logic accesses a data structure containing characterizations of at least one component communicating with the processor to establish the number of lanes.

9. A method for operating a computer, comprising:
dynamically establishing the number of lanes used to communicate with a plug-in graphics card over a PCI Express bus based on sensed temperature in the computer to maximize the number of lanes used while remaining below a temperature threshold.

10. The method of claim 9, comprising receiving a sensed temperature signal from a sensor in the computer.

11. The method of claim 9, comprising using BIOS in the computer to execute the establishing act.

12. The method of claim 11, comprising increasing the number of lanes used if adequate thermal overhead exists between the threshold and the sensed temperature.

13. The method of claim 12, comprising decreasing the number of lanes used if the sensed temperature is determined to be too high.

14. The method of claim 9, comprising accessing a data structure containing characterizations of at least one plug-in component communicating with a processor of the computer over a PCI Express bus to establish the number of lanes.

15. A computer system, comprising:
a processor supported by a housing;
a component supported by the housing;
bus means between the processor and component, the bus means including plural communication lanes; and
means for sensing temperature in the system, wherein
the processor receives signals from the sensing means and in response establishes a number of operational lanes in the bus means.

16. The system of claim 15, wherein the processor maximizes the number of lanes used while remaining below at least one temperature setpoint.

17. The system of claim 15, wherein the processor accesses BIOS to establish the number of operational lanes in the bus means.

18. The system of claim 16, wherein the processor increases the number of lanes used if adequate thermal overhead exists between the setpoint and the signals from the means for sensing.

19. The system of claim 16, wherein the processor decreases the number of lanes used if the temperature sensed by the means for sensing is determined to be too high.

20. The system of claim 15, wherein the bus means includes a PCI Express bus.
